(19) United States
(12) Patent Application Publication
(10) Pub. No.: US 2016/0144758 A1
(43) Pub. Date: May 26, 2016

(54) Van ramp

(71) Applicant: Ray Allen Knapp, Rapid City, SD (US)

(72) Inventor: Ray Allen Knapp, Rapid City, SD (US)

(21) Appl. No.: 14/544,064

(22) Filed: Nov. 20, 2014

(51) Int. Cl. B60P 1/43

(52) U.S. Cl. CPC B60P 1/435

(57) ABSTRACT

A van ramp is disclosed which may be affixed to a conventional van which has a large opening with doors in either the rear or the side of the van. The van ramp may be operated horizontally to act as a loading ramp or vertically to operate as a door to allow easy access to the interior of the van.

### BACKGROUND OF THE INVENTION

1. Field of the Invention

The present invention relates generally vehicles and more specifically to a van ramp which may be used as a ramp for vehicles which open in the rear.

2. Background Information

For many years a number of companies have been building and selling vehicles or vans which have a single large door or a couple smaller doors which may be opened at the rear end of the van and leave a substantial portion of the rear of the van open. Such vans or similar vehicles are often used by people in occupations such as the building trades. In many instances, these vans are used to carry people, tools, and supplies to a job site. In many cases, such vans are used to carry relatively heavy equipment or materials as well as tools and supplies. Because there is usually a difference in height of thirty inches or more between the ground and the floor of the van, lifting a heavy object in or out of the van may be a difficult or even dangerous task. A variety of free standing ramps are available for use in sliding a heavy object into a van, but they are awkward, difficult to use, and take up a lot of space in the van.

The van ramp of the instant invention solves problems by providing a built in ramp which may be lowered to provide a ramp for moving objects or people in or out of the van or raised and opened like a door on hinges to allow easy access to the interior of the van when not in use as a ramp. The instant invention is also simple, light weight, reliable, inexpensive, and easy to operate and maintain.

### SUMMARY OF THE INVENTION

The van ramp of the instant invention is described below as being used with one of the many conventional vans or similar vehicles which have at least one door at the rear end of the van which may be opened to provide a substantial opening in the rear of the van. It should be understood that the instant invention could be used equally well with any vehicle or trailer having a similar configuration. The device would also work with many vehicles which open at the side rather than the rear.

The van ramp of the instant invention includes a ramp which may be either hinged horizontally on the floor of the van near the rear opening of the van for use as a ramp or hinged vertically near the floor and the ceiling of the van (in the interior of the van) such that it operates as a door to allow access to the interior of the van. The invention also includes an electric motor affixed near the ceiling of the van which may be used to turn an axle. Straps are affixed to the axle and to the ramp. When the electric motor turns in one direction, the straps wind onto the axle and raises the ramp. When the electric motor turns in the other direction the straps unwind and lower the ramp.

One of the major objects of the present invention is to provide a built in ramp which may be lowered to provide a ramp for moving objects or people in or out of the van or raised and opened like a door on hinges to allow easy access to the interior of the van when not in use as a ramp.

Another objective of the present invention is to provide a van ramp which is simple, light weight, reliable, inexpensive, and easy to operate and maintain.

These and other features of the invention will become apparent when taken in consideration with the following detailed description and the drawings.

### BRIEF DESCRIPTION OF THE DRAWINGS

FIG. 1 is a rear view of a van showing the van ramp of the instant invention being used as a ramp;

FIG. 2 is a rear view of a van showing the instant invention when being used as a door;

FIG. 3 is a side view of a van showing the instant invention being used as a ramp;

FIG. 4 is a rear detail view of the base of the van ramp of the instant invention;

FIG. 5 is a side detail view of the base of the van ramp of the instant invention; and

FIG. 6 is a rear detail view of the base of the van ramp of the instant invention.

### DESCRIPTION OF A PREFERRED EMBODIMENT

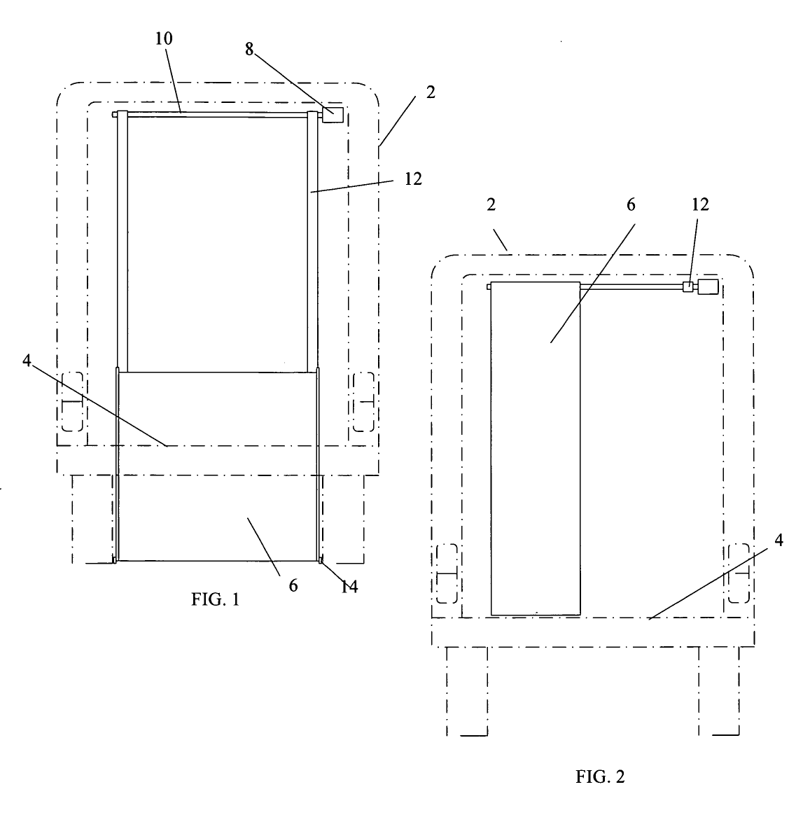

Referring to the drawings, FIGS. 1 through 6 there is shown a preferred embodiment of the instant invention.

Now referring to FIG. 1, a rear view of a van showing the van ramp if the instant invention being used as a ramp is shown. The rearward end of a typical van 2 is shown without the rear door or doors and shows the rearward end of the van largely open. The interior van floor is indicted as van floor 4. A ramp 6 is rotatably affixed to the van floor 4. An electric motor 8 is affixed to the ceiling of the interior of the van 2. The electric motor 8 is capable of turning an axle 10 which is horizontal and parallel to the top surface of the ramp 6. Two straps 12 are affixed to the axle 10 at one end near the ends of said axle 10 and are affixed to the outer edges of said ramp 6. When said electric motor 8 turns in one direction, the straps 12 are wound onto said axle 10 and said ramp 6 is lifted. When said electric motor 8 turns in the other direction, said straps 12 unwind and said ramp 6 is lowered. Wheels 14 are affixed to the outside edges of said ramp 6 near the end of said ramp 6 furthest from said van 2 such that the end of said ramp 6 rolls on the wheels 14 when said ramp 6 is raised or lowered.

Referring now to FIG. 2, a rear view of a van showing the instant invention when being used as a door is shown. In this view said ramp 6 has been fully raised using said electric motor 8. Said straps 12 have been detached from said ramp 6. In this view said ramp 6 is vertically hinged (see below for detail) at the top and bottom of the left side of said ramp 6. In this configuration, said ramp 6 may be opened or closed on the hinges (see below) and used as a door to allow access to the interior of the vehicle.

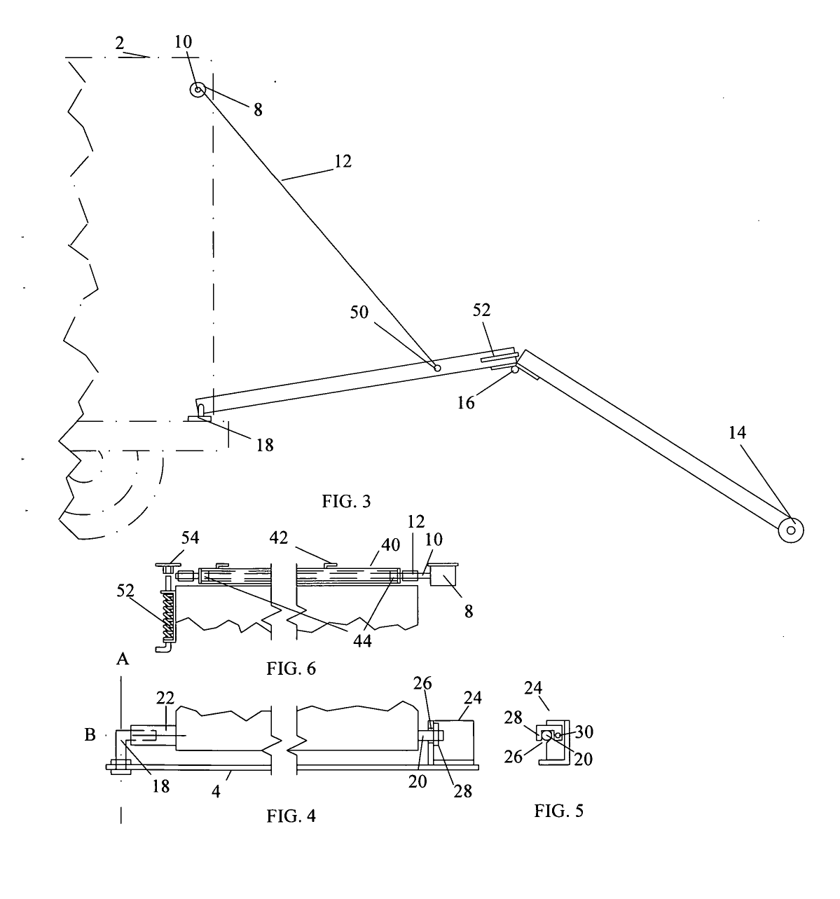

Referring now to FIG. 3, a side view of a van showing the instant invention being used as a ramp is shown. This view shows a side view of the van in the same configuration as is shown in FIG. 1. In this view, it may be seen that said ramp 6 comes in two pieces connected in the middle by a pair of ramp hinges 16. This view shows the position of said wheels 14. This view also shows the relative position of said axle 10 and the attachment point of said straps 12. Said straps 12 are removably affixed to said ramp 6 using conventional clips (not shown) to strap pins 50 which are affixed to the side of the part of said ramp 6 closest to said van 2 and located near the end of this portion of said ramp 6 furthest from said van 2. A left base pin 18 is affixed to the floor of the interior of said van 2 and rotatably affixed to the end of said ramp 6. The left base pin 18 allows said ramp 6 to rotate up and down in a plane parallel to the side of the van or to rotate on a vertical axis similar to a door as is shown in FIG. 2. This view also shows a hinge pin 20 which is affixed to the part of said ramp 6 which is affixed to said left base pin 18. A hinge pin 52 is affixed to said ramp 6 near the end of the portion of said ramp 6 which is affixed to said van 2.

Referring now to FIG. 4, a rear detail view of the base of the van ramp of the instant invention is shown. In this view it may be seen that the left base pin 18 is generally “L” shaped and one end of said left base pin 18 is rotatably affixed to said van floor 4. A collar 22 is affixed to the left side of said ramp 6 and is complimentary to the horizontal leg of said left base pin 18. The collar 22 fits over the end of the horizontal member of said left base pin 18. As may be seen, this configuration of said left base pin 18 allows said ramp 6 to rotate about either vertical axis A or about horizontal axis B. A rod clip 24 is also affixed to said van floor 4 opposite said left base pin 18. A ramp pin 20 is affixed to the end of said ramp 6 opposite said collar 22. The ramp pin 20 protrudes outward from said ramp 6 and may removably engage the rod clip 24. Said rod clip 24 includes a clip slot 26 which is capable of engaging the ramp pin 20. A rotatable clip clasp 28 may be used to capture or release said ramp pin 20 from the clip slot 26. When the clip clasp 28 has captured said ramp pin 20, said ramp 6 may rotate about said ramp pin 20 and be raised or lowered. As may be seen, said clip clasp 28 may be rotated downward to capture said ramp pin 20 or rotated upward to release said ramp pin 20.

Referring now to FIG. 5, a side detail view of the base of the van ramp of the instant invention is shown. This view shows the configuration of said rod clip 24 and illustrates the manner in which said clip slot 26 may engage said ramp pin 20. Said clip clasp 28 has the general shape of a “C” and is affixed to said rod clip 24 by means of a clip pin 30 about which it may rotate. As may be seen, by rotating said rod clip 24, said ramp pin 20 may be removably captured within said clip slot 26. When said ramp pin 20 has been captured in this manner, said rod clip 24 and said left base pin 18 acts as hinges to allow said ramp 6 to be raised or lowered.

Referring now to FIG. 6, a rear detail view of the top of the van ramp of the instant invention is shown. This view shows that the hinge pin 52 is affixed to the portion of said ramp 6 nearest said van 2 near the end of this portion of said ramp 6 which is closest to said ramp hinges 16. Said hinge pin 52 is a conventional pin with a spring and may be purchased at any hardware store. A hinge pin socket 54 is affixed to the interior of the roof of said van 2 above said hinge pin 52 and the hinge pin socket 54 may be engage by said hinge pin 52. When said hinge pin 52 is engaged, said ramp 6 may be opened or closed like a door using said hinge pin 52 and said left base pin 18. This view also show said electric motor 8 affixed to the ceiling of said van 2 and affixed to said axle 10. An axle tube 40 is provided and said axle 10 passes through said axle tube 40. The axle tube 40 may be affixed to the ceiling of said van 2 using tube clips 42. A pair of axle collars 44 fit within the two ends of said axle tube 40. The axle collars 44 act as bearings to secure said axle 10 within said axle tube 40 and allow it to rotate easily.

Thus, as may be seen, a user may release said hinge pin 52 from said hinge pin socket 54, affix said straps 12 to said ramp 6, engage said clip clasp 28 and lower said ramp using said electric motor 8. Said ramp 6 rolls on said wheels 14 until it is fully deployed. The van ramp may then be used to load or unload heavy objects from the van. When not in use, said ramp 6 may be raised using said electric motor 8 until said hinge pin 52 may be engaged within said hinge socket 54. Said straps 12 may then be disengaged from said ramp 6 and said ramp pin 20 disengaged from said clip clasp 28. Said ramp 6 may then be used as a door to allow access to the interior of said van 2.

In the preferred embodiment all elements are conventional with structural elements being made from aluminum although other materials having similar properties could be used. Said electric motor 8 may be any of a large number of conventional motors which may be powered using vehicle electricity and comes with a controller which allows an operator to set the speed and direction of rotation.

I claim:

1. A van ramp for use with a conventional van or similar vehicle where the vehicle has a door or doors which open to create a substantial opening in the rear or side of the vehicle and where the opening reaches the floor of the vehicle, comprising:
(1) a ramp which is capable of being affixed to the floor of the vehicle within the opening created in the vehicle by the opening of a door or doors near the doorway of the vehicle;
(2) a horizontal hinge being affixed to the base of the ramp such that said ramp is capable of being raised or lowered using the horizontal hinge and such that said horizontal hinge may be engaged or disengaged; and
(3) a vertical hinge being affixed to the side of said ramp such that said ramp is capable of opening or closing like a door using the vertical hinge and such that said vertical hinge may be engaged or disengaged(;)
Whereby, the van ramp may be used as a ramp to move object in or out of the van or the van ramp may be operated as a door to allow access to the interior of the van when the van ramp is not being used as a ramp.

2. A van ramp for use with a conventional van or similar vehicle where the vehicle has a door or doors which open to create a substantial opening in the rear or side of the vehicle and where the opening reaches the floor of the vehicle, comprising:
a ramp which is capable of being hinged horizontally at the floor of the vehicle near the opening such that the ramp is capable of rotating about the horizontal hinge and in which said ramp is also capable of being hinged vertically on the side of said ramp rather than horizontally such that said ramp is also capable of rotating about the vertical hinge.

3. The van ramp of claim 1 in which an horizontal axle powered by an electric motor is affixed to the interior ceiling of the vehicle, straps are affixed to the horizontal axle such that the straps are capable of being wound onto or off of said horizontal using the electric motor, and said straps are affixed to said ramp at points away from the vehicle and said electric motor is capable of being used to raise or lower said ramp.

4. The van ramp of claim 2 in which an horizontal axle powered by an electric motor is affixed to the interior ceiling of the vehicle, straps are affixed to the horizontal axle such that the straps are capable of being wound onto or off of said horizontal using the electric motor, and said straps are affixed to said ramp at points away from the vehicle and said electric motor is capable of being used to raise or lower said ramp.
